(19) United States
(12) Patent Application Publication
(10) Pub. No.: US 2002/0073339 A1
(43) Pub. Date: Jun. 13, 2002

(54) System and method to access secure information related to a user

(76) Inventor: Ronald C. Card, Hayward, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/017,988

(22) Filed: Dec. 6, 2001

Related U.S. Application Data
(60) Provisional application No. 60/254,456, filed on Dec. 7, 2000.

(51) Int. Cl. H04L 9/32

(52) U.S. Cl. 713/201

(57) ABSTRACT

A system and method to access secure information related to a user are described. Identification information related to a user is transmitted to an authentication entity. Access to a secure entity coupled to the authentication entity is received if authentication information identifying the user is provided to the secure entity.

### RELATED APPLICATIONS

The present application claims the benefit of U.S. Provisional Patent Application Serial No. 60/254,456, filed on Dec. 07, 2000, and entitled “USING A HAND-HELD ELECTRONIC DEVICE WITH BIOMETRIC CONTROL, SUCH AS A DIGITAL WALLET, AS A SECURE ACCESS POINT TO A SERVER, WEB SITE, OR MACHINE.”

### FIELD OF THE INVENTION

The present invention relates generally to electronic commerce transactions, and, more particularly, to a system and method to access secure information related to a user.

### BACKGROUND OF THE INVENTION

Electronic commerce is achieving widespread use. Transactions are performed everyday over the Internet and through point of sale (POS) or bank systems. Such transactions are typically performed after the person requesting access to some information is authenticated and access is given to that person's private information, such as financial, medical, or other type of restricted records. Present systems are designed to maintain the integrity of the user's credit card, debit card, and account number. However, no measures are taken to ensure the secure authentication of the user in order to prevent unauthorized access by a potential thief.

Presently, applications providing access to sensitive information are based upon information that a potential thief may appropriate with relative ease. For example, some of the information presently required to grant access to sensitive material, such as a person's Social Security Number, date of birth, or mother maiden's name, is readily available. Once a potential thief collects any two pieces of this information, the thief may obtain access to the person's financial, medical, or other private information. In addition, most secure access systems are set up to divulge a person's entire file, once they receive the appropriate password and/or correct answers to the security questions. Therefore, a potential thief may steal the person's identity and ruin that person's credit.

### SUMMARY OF THE INVENTION

A system and method to access secure information related to a user are described. Identification information related to a user is transmitted to an authentication entity. Access to a secure entity coupled to the authentication entity is received if authentication information identifying the user is provided to the secure entity.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a simplified block diagram of one embodiment of a secure transaction system.

FIG. 2 is a simplified block diagram of one embodiment of a privacy card for a personal transaction device.

FIG. 3 is a simplified block diagram of one embodiment of a digital wallet for a personal transaction device.

FIG. 4 is a block diagram of one embodiment of a system to access secure information related to a user.

FIG. 5 is a flow diagram of one embodiment of a method to access secure information related to a user from the perspective of a personal transaction device.

FIG. 6 is a flow diagram of the method to access secure information related to a user from the perspective of an authentication entity.

FIG. 7 is a flow diagram of the method to access secure information related to a user from the perspective of a secure entity storing the information.

FIG. 8 is a block diagram of an exemplary digital processing or computing system in which the present invention can be implemented.

### DETAILED DESCRIPTION

In the following descriptions for the purposes of explanation, numerous details are set forth in order to provide a thorough understanding of the present invention. However, it will be apparent to one skilled in the art that these specific details are not required in order to practice the present invention. In other instances, well-known electrical structures or circuits are shown in block diagram form in order not to obscure the present invention unnecessarily.

A system and method to access secure information related to a user are described in detail below. In one embodiment, identification information related to a user is transmitted to an authentication entity. Access to a secure entity coupled to the authentication entity is received if authentication information identifying the user is provided to the secure entity.

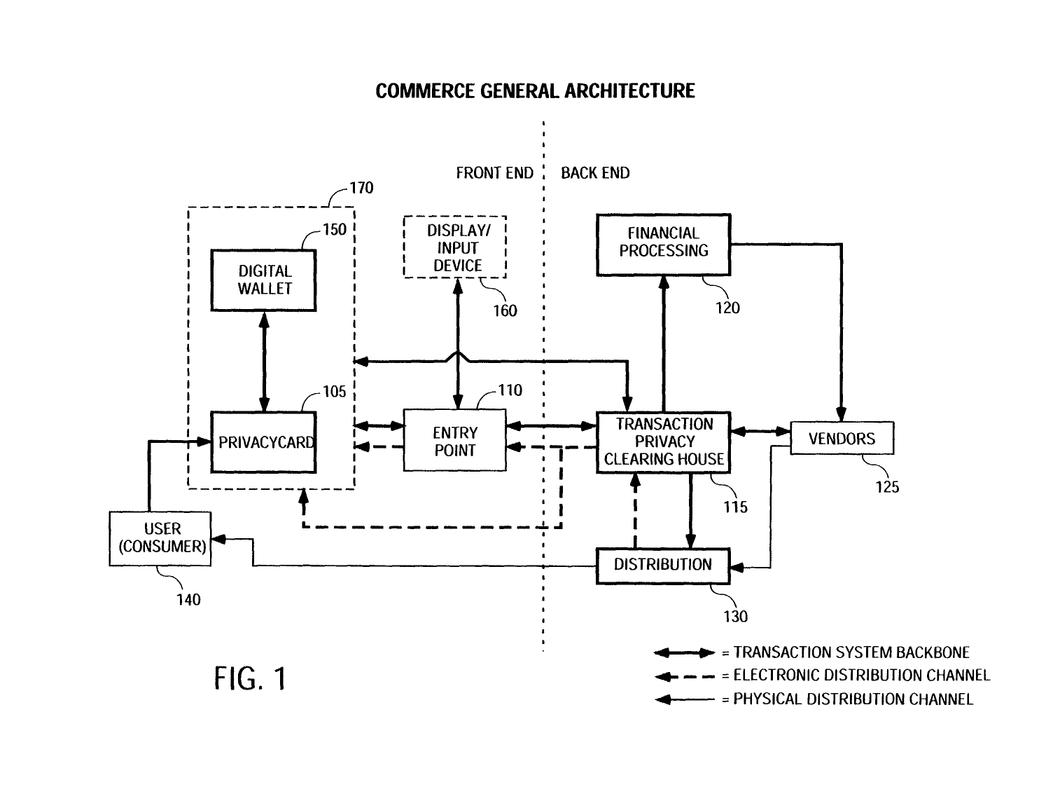

FIG. 1 is a simplified block diagram of one embodiment of a secure transaction system, which may be used in electronic commerce. As illustrated in FIG. 1, in this embodiment, a transaction privacy clearing house (TPCH) 115 interfaces a user (consumer) 140 and a vendor 125. In this particular embodiment, a personal transaction device (PTD) 170, e.g., a privacy card 105, or a privacy card 105 coupled to a digital wallet 150, is used to maintain the privacy of the user while enabling the user to perform transactions. In an alternate embodiment, the PTD 170 may be any suitable device that allows unrestricted access to TPCH 115. The personal transaction device information is provided to the TPCH 115 that then indicates to the vendor 125 and the user 140 approval of the transaction to be performed.

In order to maintain confidentiality of the identity of the user 140, the transaction device information does not provide user identification information. Thus, the vendor 125 or other entities do not have user information but rather transaction device information. The TPCH 115 maintains a secure database of transaction device information and user information. In one embodiment, the TPCH 115 interfaces to at least one financial processing system 120 to perform associated financial transactions, such as confirming sufficient funds to perform the transaction, and transfers to the vendor 125 the fees required to complete the transaction. In addition, the TPCH 115 may also provide information through a distribution system 130 that, in one embodiment, can provide a purchased product to the user 140, again without the vendor 125 knowing the identification of the user 140. In an alternate embodiment, the financial processing system 120 need not be a separate entity but may be incorporated with other functionality. For example, in one embodiment, the financial processing system 120 may be combined with the TPCH 115 functionality.

In one embodiment, the financial processing system (FP) 120 performs tasks of transferring funds between the user's account and the vendor's account for each transaction. In one embodiment, the presence of the TPCH 115 means that no details of the transactions, other than the amount of the transactions and other basic information, are known to the FP 120. The TPCH 115 issues transaction authorizations to the FP 120 function on an anonymous basis on behalf of the user over a highly secure channel. The FP 120 does not need to have many electronic channels receiving requests for fund transfer, as in a traditional financial processing system. In one embodiment, a highly secure channel is set up between the TPCH 115 and the FP 120; thus, the FP 120 is less vulnerable to spoofing.

In one embodiment, the TPCH 115 contacts the FP 120 and requests a generic credit approval of a particular account. Thus, the FP 120 receives a minimal amount of information. In one embodiment, the transaction information, including the identification of goods being purchased with the credit need not be passed to the FP 120. The TPCH 115 can request the credit using a dummy charge ID that can be listed in the monthly credit statement sent to the user, so that the user can reconcile his credit statement. Further, the personal transaction device 105 can include functionality to cause the credit statement to convert the dummy charge ID back to the transactional information so that the credit statement appears to be a conventional statement that lists the goods that were purchased and the associated amount charged.

A display input device 160 (shown in phantom) may be included to enable the user, or in some embodiments the vendor 125, to display status and provide input regarding the PTD 105 and the status of the transaction to be performed.

In yet another embodiment, an entry point 110 interfaces with the personal transaction device 170 and also communicates with the TPCH 115. The entry point 110 may be an existing (referred to herein as a legacy POS terminal) or a newly configured point of sale (POS) terminal located in a retail environment. The user 140 uses the PTD 170 to interface to the POS terminal in a manner similar to how credit cards and debit cards interface with POS terminals. The entry point 110 may also be a public kiosk, a personal computer, or the like.

The system described herein also provides a distribution functionality 130 whereby products purchased via the system are distributed. In one embodiment, the distribution function 130 is integrated with the TPCH 115 functionality. In an alternate embodiment, the distribution function 130 may be handled by a third party. Utilizing either approach, the system ensures user privacy and data security. The distribution function 130 interacts with the user through PTD 130 to ship the product to the appropriate location. A variety of distribution systems are contemplated, for example, electronic distribution through a POS terminal coupled to the network, electronic distribution direct to one or more privacy cards and/or digital wallets, or physical product distribution. In one embodiment for physical product distribution, an “anonymous drop-off point”, such as a convenience store or other ubiquitous location is used. In another embodiment, it involves the use of a “package distribution kiosk” that allows the user to retrieve the package from the kiosk in a secure fashion. However, in one embodiment, the user may use PTD 170 to change the shipping address of the product at any time during the distribution cycle.

A user connects to and performs transactions with a secure transaction system (such as shown in FIG. 1) through a personal transaction device (PTD) that has a unique identifier (ID). In one embodiment, a privacy card is used. In an alternate embodiment a digital wallet is used. In yet another alternate embodiment, a privacy card in conjunction with a digital wallet are used.

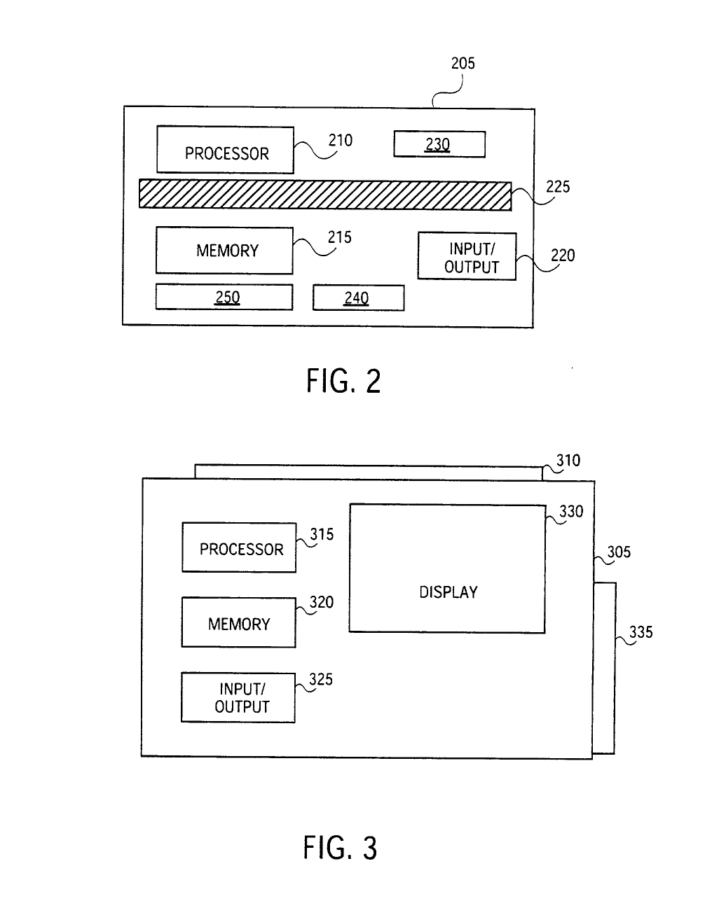

FIG. 2 is a simplified block diagram of one embodiment of a privacy card 205 for a personal transaction device. As illustrated in FIG. 2, in one embodiment, the card 205 is configured to be the size of a credit card. The privacy card includes a processor 210, memory 215 and input/output logic 220. The processor 210 is configured to execute instructions to perform the functionality herein. The instructions may be stored in the memory 215. The memory is also configured to store data, such as transaction data and the like. In one embodiment, the memory 215 stores the transaction ID used to perform transactions in accordance with the teachings of the present invention. Alternately, the processor may be replaced with specially configured logic to perform the functions described here.

The input/output logic 220 is configured to enable the privacy card 205 to send and receive information. In one embodiment, the input/output logic 220 is configured to communicate through a wired or contact connection. In another embodiment, the logic 220 is configured to communicate through a wireless or contactless connection. A variety of communication technologies may be used.

In one embodiment, a display 225 is used to generate bar codes scanable by coupled devices and used to perform processes as described herein. The privacy card 205 may also include a magnetic stripe generator 240 to simulate a magnetic stripe readable by devices such as legacy POS terminals.

In one embodiment, biometric information, such as fingerprint recognition, is used as a security mechanism that limits access to the card 205 to authorized users. A fingerprint touch pad and associated logic 230 is therefore included in one embodiment to perform these functions. Alternately, security may be achieved using a smart card chip interface 250, which uses known smart card technology to perform the function. A suitable biometric control device that may be used is described in U.S. patent application Ser. No. 09/510,811, entitled “Method of Using a Personal Device with Internal Biometric Control in Conducting Transactions Over a Network,” which is herein incorporated by reference.

Memory 215 can have transaction history storage area. The transaction history storage area stores transaction records (electronic receipts) that are received from POS terminals. The ways for the data to be input to the card include wireless communications and the smart card chip interface which functions similar to existing smart card interfaces. Both of these approaches presume that the POS terminal is equipped with the corresponding interface and can therefore transmit the data to the card.

Memory 215 can also have user identity/account information block. The user identity/account information block stores data about the user and accounts that are accessed by the card. The type of data stored includes the meta account information used to identify the account to be used.

FIG. 3 is a simplified block diagram of one embodiment of a digital wallet 305 for a personal transaction device. As illustrated in FIG. 3, the digital wallet 305 includes a coupling input 310 for the privacy card 205, processor 315, memory 320, input/output logic 225, display 330 and peripheral port 335. The processor 315 is configured to execute instructions, such as those stored in memory 320, to perform the functionality described herein. Memory 320 may also store data including financial information, eCoupons, shopping lists and the like. The digital wallet may be configured to have additional storage. In one embodiment, the additional storage is in a form of a card that couples to the device through peripheral port 310.

In one embodiment, the privacy card 205 couples to the digital wallet 305 through port 310; however, the privacy card 205 may also couple to the digital wallet 305 through another form of connection including a wireless connection.

Input/output logic 325 provides the mechanism for the digital wallet 305 to communicate information. In one embodiment, the input/output logic 325 provides data to a point-of-sale terminal or to the privacy card 205 in a pre-specified format. The data may be output through a wired or wireless connection.

The digital wallet 305 may also include a display 330 for display of status information to the user. The display 330 may also provide requests for input and may be a touch sensitive display, enabling the user to provide the input through the display.

The physical manifestation of many of the technologies in the digital wallet 305 will likely be different from those in the privacy card 205, mainly because of the availability of physical real estate in which to package technology. Examples of different physical representations would include the display, fingerprint recognition unit, etc.

The components of a secure transaction system illustrated in FIGS. 1, 2, and 3 are further described in International Application published under the Patent Cooperation Treaty (PCT), International Publication Number WO 01/52212, filed on Dec. 28, 2000, and entitled “Secure Electronic Commerce System,” which is assigned to the same assignee as the present application and which is hereby incorporated by reference.

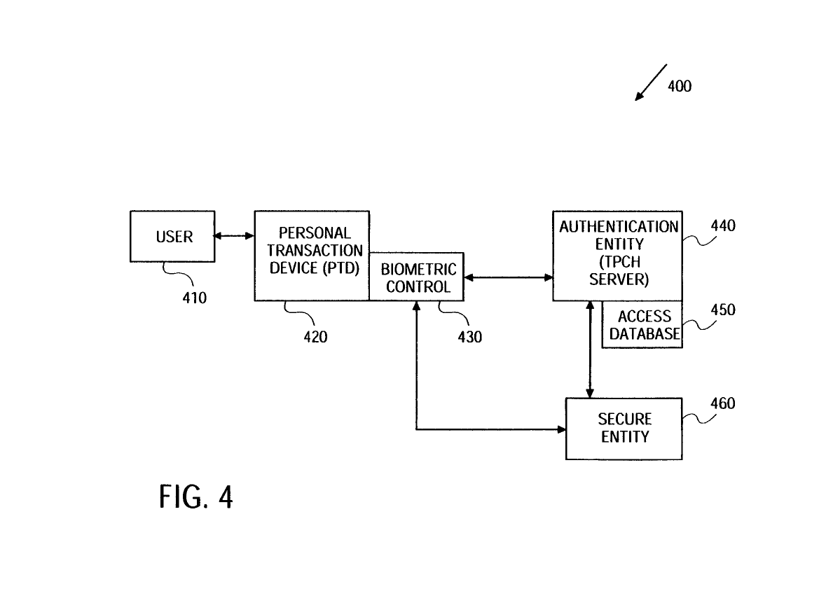

FIG. 4 is a block diagram for one embodiment of a system to access secure information related to a user. Referring to FIG. 4, in one embodiment of the system 400, a user 410 communicates with an authentication entity 440, for example a TPCH server, via a personal transaction device (PTD) 420. Alternatively, multiple users 410 may be connected to TPCH server 440 using corresponding PTDs 420. In the embodiment of FIG. 4, the user 410 and TPCH 440 communicate via a network implemented in a wired or wireless environment. The network may be the Internet, which is a worldwide system of interconnected networks that runs the Internet Protocol (IP) to transfer data, or other types of networks, such as a token ring network, a local area network (LAN), or a wide area network (WAN).

PTD 420 further includes a biometric control module 430, which allows PTD 420 to communicate securely with user 410 using biometric information, such as fingerprint recognition. TPCH server 440 further includes an access database 450, for example an access list, containing authentication information related to the user 410, for example user identification information and a level of authentication corresponding to the user 410, as described in further detail below. Alternatively, the access database 450 contains authentication information related to multiple users 410, which would uniquely identify other users 410 that may access the secure data.

In one embodiment, the system 400 further includes secure entity 460, for example a secure server, connected to TPCH server 440 and to PTD 420. Alternatively, any number of secure entities 460 may communicate with TPCH server 440. Secure server 460 contains secure data accessible to the user 410 upon completion of an authentication process described in further detail below. In one embodiment, secure server 460 may be another user, similar to user 410, which may share secure data with the user 410 upon completion of the authentication process.

In one embodiment, secure server 460 is connected to TPCH server 440 and to PTD 420 via a network implemented in a wired or wireless environment. The network may be the Internet, which is a worldwide system of interconnected networks that runs the Internet Protocol (IP) to transfer data, or other types of networks, such as a token ring network, a local area network (LAN), or a wide area network (WAN). Alternatively, secure server 460 may be connected directly to the PTD 420 via a wired or wireless connection.

Prior to gaining access to the secure data stored in secure server 460, the user 410 transmits registration information to TPCH server 440. In one embodiment, the registration information includes identification information for the user 410, such as personal information, specific locations used to access the secure data, and PTD 420 identification information. Alternatively, the transmitted registration information may include other information necessary to identify the user 410, for example, an unlock key provided by biometric control 430 connected to PTD 420.

In one embodiment, the user identification information includes predetermined access questions specifically tailored by the user 410 to uniquely identify and authenticate the user 410. Alternatively, TPCH server 440 may create the predetermined access questions based on the user identification information. The predetermined access questions refer to personal information related to the user 410, which is available only to the user 410 and to TPCH server 440.

Subsequently, TPCH server 440 stores the access questions and one or more levels of authentication for the user 410 in a user profile within access database 450. In one embodiment, the level of authentication granted to the user 410 is based on the stored user profile and on the location used to access the secure data. For example, if user 410 is at his or her residence or in the office, full access to the secure data may be granted. However, if user 410 decides to access data from a public kiosk or from a telephone booth, the access may be limited.

When the user 410 decides to access the secure data stored in secure server 460, PTD 420 associated with the user 410 contacts secure server 460 and transmits an access request to retrieve secure data. Secure server 460 receives the access request and transmits an authentication request to authenticate the user 410. In one embodiment, the authentication request contains a request to provide authentication information related to the user 410, which is requesting access to the secure data.

In one embodiment, secure server 460 transmits the authentication request directly to TPCH server 440. Alternatively, secure server 460 may transmit the authentication request directly to PTD 420. If the authentication request is transmitted directly to TPD 420, TPD 420 subsequently forwards the authentication request to TPCH server 440.

After receiving the authentication request, either directly from secure server 460 or through TPD 420, TPCH server 440 retrieves the user profile and the predetermined access questions related to the user 410, and transmits the access questions to PTD 420.

In one embodiment, the user 410 receives the access questions through PTD 420 and provides answers to the access questions. PTD 420 transmits the answers to the access questions to TPCH server 440. TPCH server 440 receives the answers, authenticates the user 410 to access the secure data, and provides an appropriate level of authentication for the user 410.

In one embodiment, TPCH server 440 transmits the authentication information directly to secure server 460. Alternatively, TPCH server 440 may transmit the authentication information directly to TPD 420. If the authentication information is transmitted directly to TPD 420, TPD 420 subsequently forwards the authentication information to secure server 460. Finally, secure server 460 grants access to the secure data based on the appropriate level of authentication.

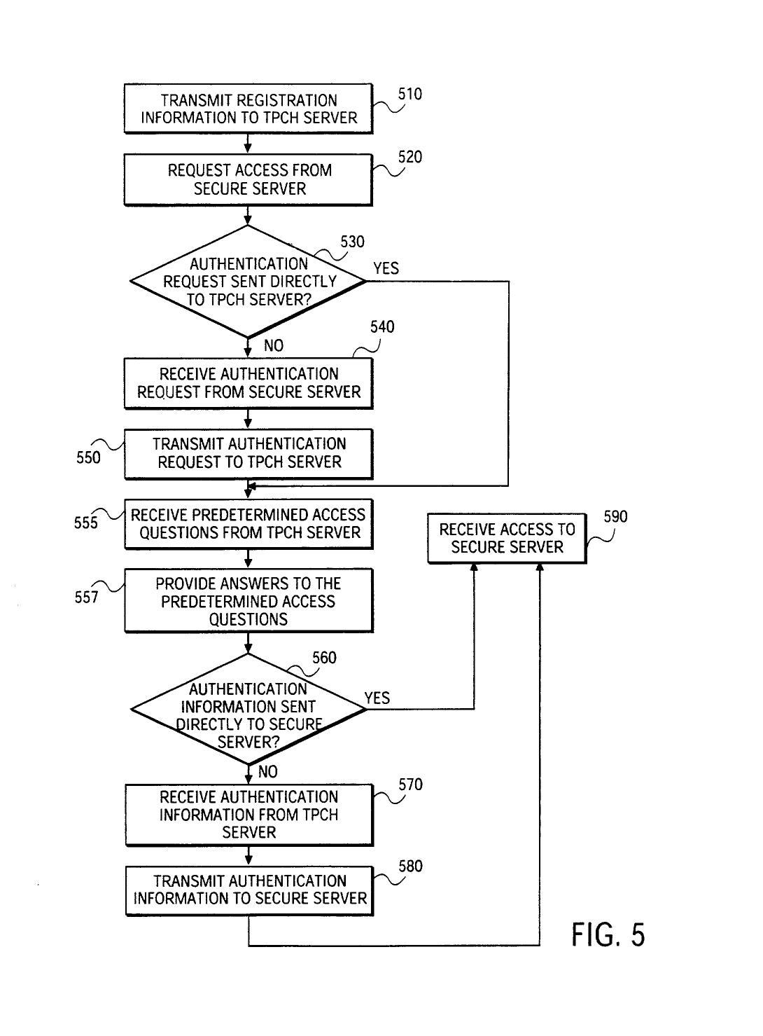

FIG. 5 is a flow diagram of one embodiment of a method to access secure information related to a user from the perspective of a personal transaction device. As illustrated in FIG. 5, at processing block 510, PTD 420 transmits registration information to the TPCH server 440. In one embodiment, the registration information includes user identification information and PTD 420 identification information. The user identification information further includes predetermined access questions tailored by the user 410 to uniquely identify the user 410. Alternatively, TPCH server 440 creates the predetermined access questions based on the user identification information.

At processing block 520, PTD 420 contacts secure server 460 and requests access to the secure data. In one embodiment, the user 410 contacts secure server 460 through PTD 420 and transmits an access request to retrieve secure data.

At processing block 530, a decision is made whether an authentication request is sent directly to TPCH server 440. In one embodiment, the secure server 460 transmits the authentication request directly to TPCH server 440. Alternatively, the authentication request may be sent to PTD 420.

If the authentication request is transmitted directly to TPCH server 440, then, the process jumps to processing block 555. Otherwise, if the authentication request is not sent through TPCH server 440, at processing block 540, PTD 420 receives the authentication request directly from secure server 460. At processing block 550, PTD 420 transmits the authentication request to TPCH server 440.

At processing block 555, TPD 420 receives the predetermined access questions from TPCH server 440. At processing block 537, the user 410 provides answers to the access questions and TPD 420 transmits the answers to TPCH server 440.

At processing block 560, another decision is made whether the authentication information is sent directly to secure server 460. In one embodiment, TPCH server 440 transmits the authentication information directly to secure server 460. Alternatively, TPCH server 440 may transmit the authentication information directly to PTD 420. If the authentication information is transmitted directly to secure server 460, then, at processing block 590, PTD 420 receives access to secure server 460. Otherwise, if the authentication information is not sent directly to secure server 460, at processing block 470, PTD 420 receives the authentication information from TPCH server 440.

At processing block 580, PTD 420 transmits the authentication information to secure server 460. Finally, the process ends at processing block 590, where PTD 420 receives access to secure server 460.

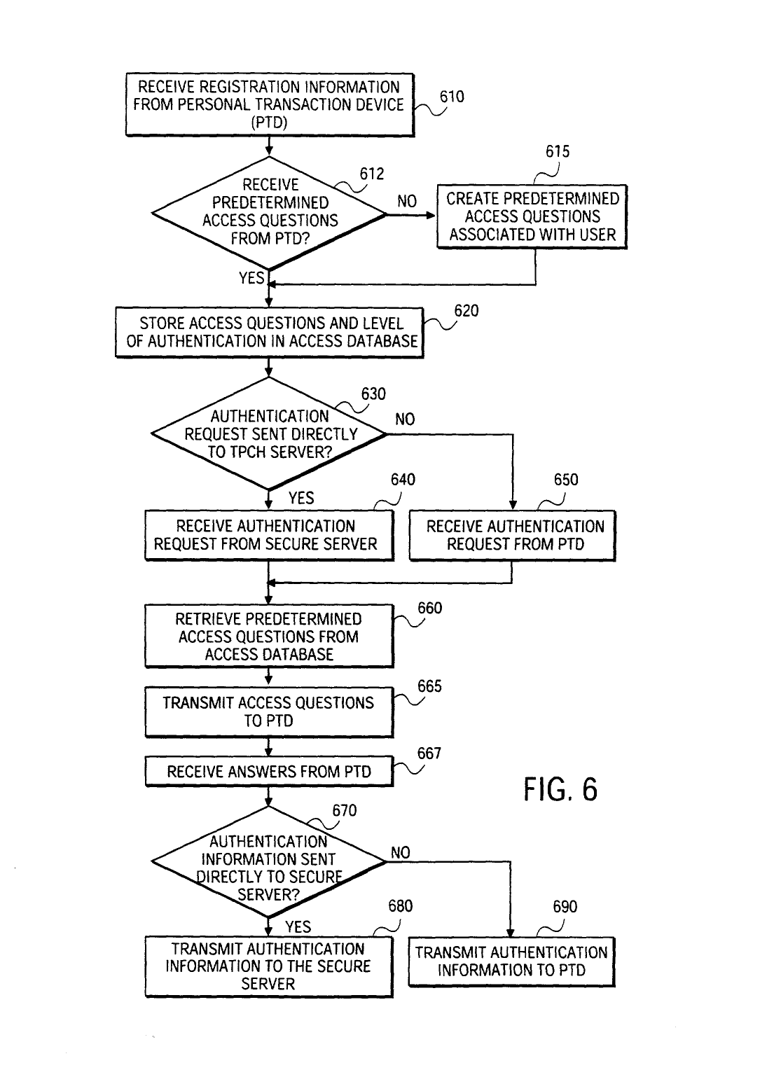

FIG. 6 is a flow diagram of the method to access secure information related to a user from the perspective of an authentication entity. As illustrated in FIG. 6, at processing block 610, the authentication entity, for example TPCH server 440, receives the registration information from PTD 420.

At processing block 612, a decision is made whether predetermined access questions were received from PTD 420. If the access questions were not received, at processing block 615, TPCH server 440 creates the predetermined access questions based on the user identification information included in the registration information related to the user 410.

If the access questions were received from PTD 420, at processing block 620, TPCH server 440 stores authentication information related to the user 410, for example, access questions and one or more levels of authentication, in a user profile within access database 450.

At processing block 630, a decision is made whether an authentication request is sent directly to TPCH server 440. In one embodiment, secure server 460 transmits the authentication request directly to TPCH server 440. Alternatively, the authentication request may be sent directly to PTD 420.

If the authentication request is transmitted to TPCH server 440, then, at processing block 640, the authentication request is received from the secure server 460. Otherwise, if the authentication request is not sent to TPCH server 440, at processing block 650, the authentication request is received from PTD 420. Subsequently, at processing block 660, authentication information related to the user 410, for example, the user profile containing the predetermined access questions, is retrieved from the access database 450.

At processing block 665, TPCH server 440 transmits the access questions to PTD 420. At processing block 667, TPCH server 440 receives answers to the access questions from PTD 420. In one embodiment, TPCH server 440 authenticates the user 410 to access the secure data and provides an appropriate level of authentication for the user 410.

At processing block 670, another decision is made whether the authentication information is sent directly to secure server 460. In one embodiment, at processing block 680, TPCH server 440 transmits the authentication information directly to secure server 460. Otherwise, at processing block 690, TPCH server 440 transmits the authentication information directly to PTD 420.

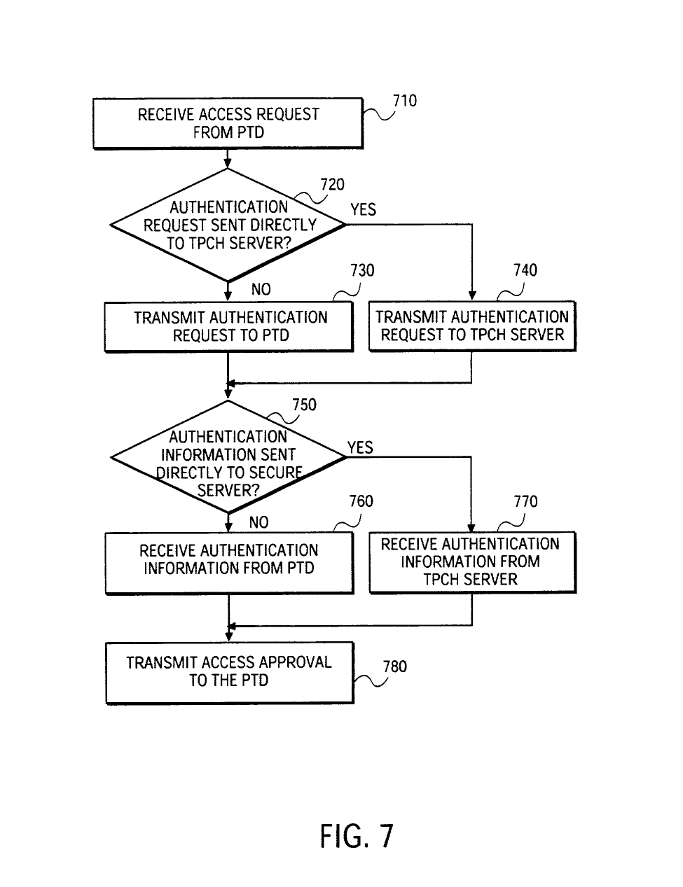

FIG. 7 is a flow diagram of the method to access secure information related to a user from the perspective of a secure entity storing the information. As illustrated in FIG. 7, at processing block 710, secure server 460 receives an access request from PTD 420 connected to the user 410.

At processing block 720, a decision is made whether an authentication request is sent directly to TPCH server 440. In one embodiment, at processing block 740, secure server 460 transmits the authentication request directly to TPCH server 440. Alternatively, at processing block 730, secure server 460 may transmit the authentication request directly to PTD 420.

At processing block 750, another decision is made whether the authentication information is sent directly to secure server 460. In one embodiment, if the authentication information is sent directly to secure server 460, at processing block 770, secure server 460 receives the authentication information from TPCH server 440. Alternatively, at processing block 760, secure server 460 receives the authentication information from PTD 420.

Finally, at processing block 780, based on the authentication information, the secure server 460 transmits the access approval to PTD 420.

In one embodiment, secure server 460 may be another user, similar to the user 410, and may contain data to be shared among users. In this embodiment, secure server 460 transmits a list of authenticated users to TPCH server 440, which uniquely identifies other users 410 that may access the information, as described in detail above. TPCH server 440 may then store authentication information related to each authenticated user 410 of the multiple authenticated users present on the list and may determine access rights for any user 410 trying to retrieve shared data from secure server 460.

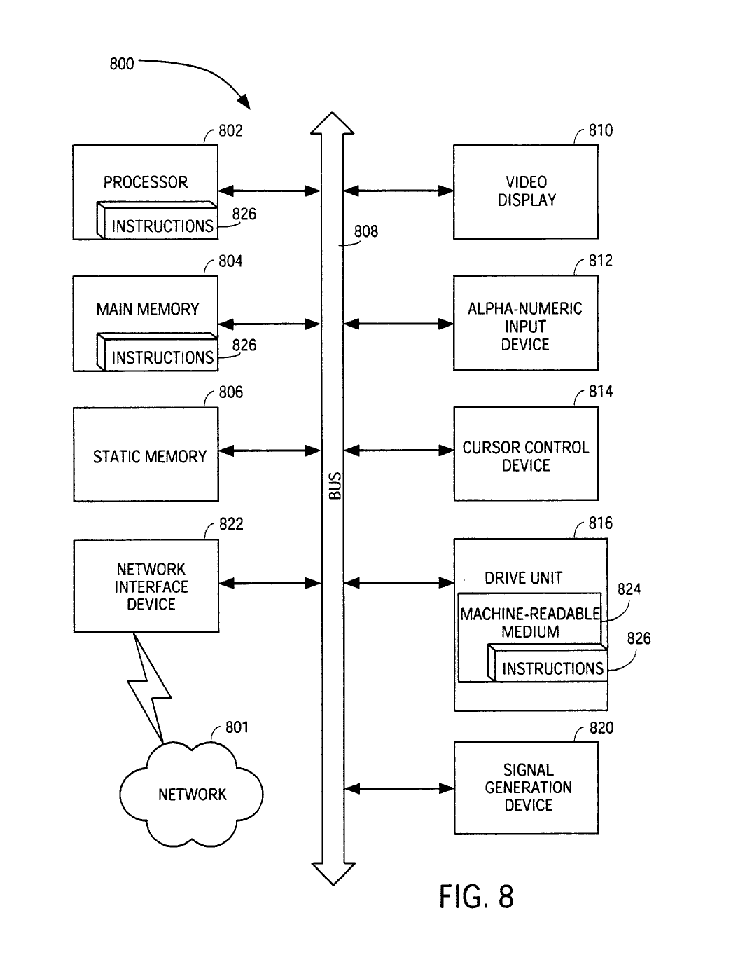

FIG. 8 is a block diagram of an exemplary digital processing or computing system 800 in which the present invention can be implemented. For example, digital processing system 800 can represent TPCH server 440 or personal transaction device 420, as described in FIG. 4. Digital processing system 800 may store a set of instructions for causing the system to perform any of the operations described above. Digital processing system 800 can also represent a network device, which includes a network router, switch, bridge, or gateway.

Referring to FIG. 8, digital processing system 800 includes a bus 808 coupled to a central processing unit (CPU) 802, main memory 804, static memory 806, network interface 822, video display 810, alpha-numeric input device 812, cursor control device 814, drive unit 816, and signal generation device 820. The devices coupled to bus 808 can use bus 808 to communicate information or data to each other. Furthermore, the devices of digital processing system 800 are exemplary in which one or more devices can be omitted or added. For example, one or more memory devices can be used for digital processing system 800.

The CPU 802 can process instructions 826 stored either in main memory 804 or in a machine-readable medium 824 within drive unit 816 via bus 808. For one embodiment, CPU 802 can process and execute instructions 826 to implement the operations described above. Bus 808 is a communication medium for communicating data or information for digital processing system 800.

Main memory 804 can be, e.g., a random access memory (RAM) or some other dynamic storage device. Main memory 804 stores instructions 826, which can be used by CPU 802. Main memory 804 may also store temporary variables or other intermediate information during execution of instructions by CPU 802. Static memory 806 can be, e.g., a read only memory (ROM) and/or other static storage devices, for storing information or instructions, which can also be used by CPU 802. Drive unit 816 can be, e.g., a hard or floppy disk drive unit or optical disk drive unit, having a machine-readable medium 824 storing instructions 826. The machine-readable medium 824 can also store other types of information or data.

Video display 810 can be, e.g., a cathode ray tube (CRT) or liquid crystal display (LCD). Video display device 810 displays information or graphics to a user. Alphanumeric input device 812 is an input device (e.g., a keyboard) for communicating information and command selections to digital processing system 800. Cursor control device 814 can be, e.g., a mouse, a trackball, or cursor direction keys, for controlling movement of an object on video display 810. Signal generation device 820 can be, e.g., a speaker or a microphone.

Digital processing system 800 can be connected to a network 801 via a network interface device 822. Network interface 822 can connect to a network such as, for example, a local area network (LAN), wide area network (WAN), token ring network, Internet, or other like networks. Network interface device 822 can also support varying network protocols such as, for example, hypertext transfer protocol (HTTP), asynchronous transfer mode (ATM), fiber distributed data interface (FDDI), frame relay, or other like protocols.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

The invention has been described in conjunction with the preferred embodiment. It is evident that numerous alternatives, modifications, variations and uses will be apparent to those skilled in the art in light of the foregoing description.

### APPENDIX A

Ramin Aghevli, Reg. No. 43,462; William E. Alford, Reg. No. 37,764; Farzad E. Amini, Reg. No. 42,261; William Thomas Babbitt, Reg. No. 39,591; Jordan Michael Becker, Reg. No. 39,602; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Jae-Hee Choi, Reg No. 45,288; Thomas M. Coester, Reg. No. 39,637; Robert P. Cogan, Reg. No. 25,049; Donna Jo Coningsby, Reg. No. 41,684; Florin Corie, Reg. No. 46,244; Mimi Diemmy Dao, Reg. No. 45,628; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; Andre Gibbs, Reg. No. 47,593; James Y. Go, Reg. No. 40,621; Melissa A. Haapala, Reg No. 47,622; Alan Heimlich, Reg. No. 48,808; James A. Henry, Reg. No. 41,064; Libby H. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Walter T. Kim, Reg. No. 42,731; Eric T. King, Reg. No. 44,188; Steve Laut, Reg. No. 47,736; George Brian Leavell, Reg. No. 45,436; Samuel S. Lee, Reg. No. 42791; Gordon R. Lindeen III, Reg. No. 33,192; Jan Carol Little, Reg. No. 41,181; Julio Loza, Reg. No. 47,758; Joseph Lutz, Reg. No. 43,765; Michael J. Mallie, Reg. No. 36,591; Andre L. Marais, Reg. No. 48,095; Paul A. Mendonsa, Reg. No. 42,879; Clive D. Menezes, Reg. No. 45,493; Richard A. Nakashima, Reg. No. 42,023; Stephen Neal Reg. No. 47,815; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Gregg A. Peacock, Reg. No. 45,001; Marina Portnova, Reg. No. 45,750; Michael A. Proksch, Reg. No. 43,021; Randol W. Read, Reg. No. 43,876; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; Saina Shamilov, Reg. No. 48,266; Maria McCormack Sobrino, Reg. No. 31,639; Stanley W. Sokoloff, Reg. No. 25,128; Judith A. Szepesi, Reg. No. 39,393; Ronald S. Tamura, Reg. No. 43,179; Edwin H. Taylor, Reg. No. 25,129; Lance A. Termes, Reg. No. 43,184; John F. Travis, Reg. No. 43,203; Kerry P. Tweet, Reg. No. 45,959; Mark C. Van Ness, Reg. No. 39,865; Tom Van Zandt, Reg. No. 43,219; Brent Vecchia, Reg No. 48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Charles P. Landrum, Reg. No. 46,855; Suk S. Lee, Reg. No. 47,745; and Raul Martinez, Reg. No. 46,904, Brent E. Vecchia, Reg. No. 48,01 1; Lehua Wang, Reg. No. P48,023; my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James R. Thein, Reg. No. 31,710, my patent attorney with full power of substitution and revocation, to prosecute this application and to transact all business in the Patent and Trademark Office connected herewith.

### APPENDIX B

Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. A method comprising:
transmitting identification information related to a user to an authentication entity; and
receiving access to a secure entity coupled to said authentication entity if authentication information identifying said user is provided to said secure entity.

2. The method according to claim 1, wherein said transmitting further comprises:
transmitting at least one access question to said authentication entity, said at least one access question being tailored by said user based on said identification information in order to uniquely identify and authenticate said user.

3. The method according to claim 1, wherein said authentication information includes a level of authentication related to a location of said user when requesting said access.

4. The method according to claim 1, wherein said authentication information is based on a profile of said user stored in said authentication entity.

5. The method according to claim 4, wherein said profile contains said identification information related to said user and at least one level of authentication related to a location of said user when requesting said access.

6. The method according to claim 2, wherein said receiving further comprises:
receiving an authentication request from said secure entity;
transmitting said authentication request to said authentication entity;
receiving said at least one access question from said authentication entity; and
transmitting an answer to said at least one access question to said authentication entity to authenticate said user.

7. The method according to claim 2, wherein said receiving further comprises:
receiving said at least one access question from said authentication entity; and
transmitting an answer to said at least one access question to said authentication entity to authenticate said user.

8. The method according to claim 2, wherein said transmitting further comprises establishing biometric access to said authentication entity using a biometric control module.

9. The method according to claim 1, wherein said receiving further comprises:
receiving at least one access question from said authentication entity, said at least one access question being created by said authentication entity based on said identification information in order to uniquely identify and authenticate said user; and
providing an answer to said at least one access question to said authentication entity to authenticate said user.

10. The method according to claim 1, wherein said secure entity specifies a plurality of authenticated users to said authentication entity and said authentication entity stores said authentication information related to each authenticated user of said plurality of authenticated users.

11. The method according to claim 1, wherein said authentication entity is a transaction privacy clearing house (TPCH) server.

12. A method comprising:
receiving an authentication request related to a user requesting access to a secure entity;
retrieving a profile of said user from an access database, said profile containing at least one access question uniquely identifying said user; and
transmitting authentication information to said secure entity based on an answer to said at least one access question received from said user.

13. The method according to claim 12, wherein said authentication request is received directly from said secure entity.

14. The method according to claim 12, wherein said authentication request is received from a personal transaction device coupled to said user and to said secure entity.

15. The method according to claim 12, wherein said authentication information is transmitted directly to said secure entity.

16. The method according to claim 12, wherein said authentication information is transmitted to a personal transaction device coupled to said user and to said secure entity.

17. The method according to claim 12, further comprising:
receiving identification information related to said user from a personal transaction device coupled to said user and said secure entity, said identification information including said at least one access question; and
storing said at least one access question and at least one level of authentication in said profile within said access database, said at least one level of authentication being related to a location of said user when requesting said access.

18. The method according to claim 17, wherein said personal transaction device establishes biometric access to transmit said identification information using a biometric control module.

19. The method according to claim 12, wherein said authentication information includes a level of authentication related to a location of said user when requesting said access.

20. The method according to claim 12, further comprising:
receiving identification information related to said user from a personal transaction device coupled to said user and said secure entity;
creating said at least one access question based on said identification information; and
storing said at least one access question and at least one level of authentication in said profile within said access database, said at least one level of authentication being related to a location of said user when requesting said access.

21. A system comprising:
a personal transaction device connected to a user requesting access to a secure entity; and
an authentication entity connected to said personal transaction device and said secure entity to retrieve a profile of said user from an access database in response to an authentication request related to said user, said profile containing at least one access question uniquely identifying said user, and to transmit authentication information identifying said user to said secure entity, based on an answer to said at least one access question received from said user.

22. The system according to claim 21, wherein said authentication request is received directly from said secure entity.

23. The system according to claim 21, wherein said authentication request is received from said secure entity through said personal transaction device.

24. The system according to claim 21, wherein said authentication entity further transmits said authentication information directly to said secure entity.

25. The system according to claim 21, wherein said authentication entity further transmits said authentication information to said secure entity through said personal transaction device.

26. The system according to claim 21, wherein said authentication entity further receives identification information related to said user from said personal transaction device, said identification information including said at least one access question and further stores said at least one access question and at least one level of authentication in said profile within said access database, said at least one level of authentication being related to a location of said user when requesting said access.

27. The system according to claim 21, wherein said authentication information includes a level of authentication related to a location of said user when requesting said access.

28. The system according to claim 21, wherein said authentication entity further receives identification information related to said user from said personal transaction device, creates said at least one access question based on said identification information, and stores said at least one access question and at least one level of authentication in said profile within said access database, said at least one level of authentication being related to a location of said user when requesting said access.

29. The system according to claim 28, wherein said personal transaction device establishes biometric access to transmit said identification information using a biometric control module.

30. The system according to claim 21, wherein said personal transaction device receives said at least one access question from said authentication entity and transmits said answer to said authentication entity to authenticate said user.

31. An apparatus comprising:
means for transmitting identification information related to a user to an authentication entity; and
means for receiving access to a secure entity coupled to said authentication entity if authentication information identifying said user is provided to said secure entity.

32. The apparatus according to claim 31, further comprising:
means for transmitting at least one access question to said authentication entity, said at least one access question being tailored by said user based on said identification information in order to uniquely identify and authenticate said user.

33. The apparatus according to claim 32, further comprising:
means for receiving an authentication request from said secure entity;
means for transmitting said authentication request to said authentication entity;
means for receiving said at least one access question from said authentication entity; and
means for transmitting an answer to said at least one access question to said authentication entity to authenticate said user.

34. The apparatus according to claim 32, further comprising:
means for receiving said at least one access question from said authentication entity; and
means for transmitting an answer to said at least one access question to said authentication entity to authenticate said user.

35. The apparatus according to claim 32, further comprising means for establishing biometric access to said authentication entity using a biometric control module.

36. The apparatus according to claim 31, further comprising:
means for receiving at least one access question from said authentication entity, said at least one access question being created by said authentication entity based on said identification information in order to uniquely identify and authenticate said user; and
means for providing an answer to said at least one access question to said authentication entity to authenticate said user.

37. An apparatus comprising:
means for receiving an authentication request related to a user requesting access to a secure entity;
means for retrieving a profile of said user from an access database, said profile containing at least one access question uniquely identifying said user; and
means for transmitting authentication information to said secure entity based on an answer to said at least one access question received from said user.

38. The apparatus according to claim 37, further comprising:
means for receiving identification information related to said user from a personal transaction device coupled to said user and said secure entity, said identification information including said at least one access question; and
means for storing said at least one access question and at least one level of authentication in said profile within said access database, said at least one level of authentication being related to a location of said user when requesting said access.

39. The apparatus according to claim 37, further comprising:
means for receiving identification information related to said user from a personal transaction device coupled to said user and said secure entity;
means for creating said at least one access question based on said identification information; and
means for storing said at least one access question and at least one level of authentication in said profile within said access database, said at least one level of authentication being related to a location of said user when requesting said access.

40. A computer readable medium containing executable instructions, which, when executed in a processing system, cause said processing system to perform a method comprising:
transmitting identification information related to a user to an authentication entity; and
receiving access to a secure entity coupled to said authentication entity if authentication information identifying said user is provided to said secure entity.

41. The computer readable medium according to claim 40, wherein said transmitting further comprises:
transmitting at least one access question to said authentication entity, said at least one access question being tailored by said user based on said identification information in order to uniquely identify and authenticate said user.

42. The computer readable medium according to claim 41, wherein said receiving further comprises:
receiving an authentication request from said secure entity;
transmitting said authentication request to said authentication entity;
receiving said at least one access question from said authentication entity; and
transmitting an answer to said at least one access question to said authentication entity to authenticate said user.

43. The computer readable medium according to claim 41, wherein said receiving further comprises:
receiving said at least one access question from said authentication entity; and
transmitting an answer to said at least one access question to said authentication entity to authenticate said user.

44. The computer readable medium according to claim 41, wherein said transmitting further comprises establishing biometric access to said authentication entity using a biometric control module.

45. The computer readable medium according to claim 40, wherein said receiving further comprises:
receiving at least one access question from said authentication entity, said at least one access question being created by said authentication entity based on said identification information in order to uniquely identify and authenticate said user; and
providing an answer to said at least one access question to said authentication entity to authenticate said user.

46. A computer readable medium containing executable instructions, which, when executed in a processing system, cause said processing system to perform a method comprising:
receiving an authentication request related to a user requesting access to a secure entity;
retrieving a profile of said user from an access database, said profile containing at least one access question uniquely identifying said user; and
transmitting authentication information to said secure entity based on an answer to said at least one access question received from said user.

47. The computer readable medium according to claim 46, wherein said method further comprises:
receiving identification information related to said user from a personal transaction device coupled to said user and said secure entity, said identification information including said at least one access question; and
storing said at least one access question and at least one level of authentication in said profile within said access database, said at least one level of authentication being related to a location of said user when requesting said access.

48. The computer readable medium according to claim 46, wherein said method further comprises:
receiving identification information related to said user from a personal transaction device coupled to said user and said secure entity;
creating said at least one access question based on said identification information; and
storing said at least one access question and at least one level of authentication in said profile within said access database, said at least one level of authentication being related to a location of said user when requesting said access.
